(19) United States
(12) Patent Application Publication
(10) Pub. No.: US 2005/0110427 A1
(43) Pub. Date: May 26, 2005

(54) Decorative light strings

(76) Inventor: W. Richard Frederick, Hardy, VA (US)

Correspondence Address: JENKENS & GILCHRIST, P.C., 225 WEST WASHINGTON, SUITE 2600, CHICAGO, IL, 60606, US

(21) Appl. No.: 10/722,269

(22) Filed: Nov. 24, 2003

(51) Int. Cl. H05B 37/00

(52) U.S. Cl. 315/185 S; 315/185 R; 315/312

(57) ABSTRACT

One or more strings of decorative lights are supplied with power by converting a standard residential electrical voltage to a low-voltage, and supplying the low-voltage to at least one pair of parallel conductors having multiple decorative lights connected to the conductors along the lengths thereof, each of the lights, or groups of the lights, being connected in parallel across the conductors. A repair device for fixing a malfunctioning shunt across a failed filament in a light bulb in a group of series-connected miniature decorative bulbs includes a high-voltage pulse generator producing one or more pulses of a magnitude greater than the standard AC power line voltage. A connector receives the pulses from the pulse generator and supplies them to the group of series-connected miniature decorative bulbs. The pulse generator may be a piezoelectric pulse generator, a battery-powered electronic pulse generator, and/or an AC-powered electrical pulse generator.

### FIELD OF THE INVENTION

The present invention relates to decorative lights, including lights for Christmas trees, including pre-strung or “pre-lit” artificial trees.

### SUMMARY OF THE INVENTION

In accordance with the present invention, one or more strings of decorative lights are supplied with power by converting a standard residential electrical voltage to a low-voltage, and supplying the low-voltage to at least one pair of parallel conductors having multiple decorative lights connected to the conductors along the lengths thereof, each of the lights, or groups of the lights, being connected in parallel across the conductors. A string of decorative lights embodying this invention comprises a power supply having an input adapted for connection to a standard residential electrical power outlet, the power supply including circuitry for converting the standard residential voltage to a low-voltage output; a pair of conductors connected to the output of the power supply for supplying the low-voltage output to multiple decorative lights; and multiple lights connected to the conductors along the lengths thereof, each of the lights, or groups of the lights, being connected in parallel across the conductors. The lights preferably require voltages of about 6 volts or less, and are preferably connected in parallel groups of 2 to 5 lights per group with the lights within each group being connected in series with each other.

The parallel groups are useful for current management. Light strings typically have 100 bulbs, and 100 6-volt bulbs drawing 80 ma./bulb in parallel requires a total current flow of 8 amps, which requires relatively thick wires. With the series/parallel groups, the total current and the wire size can both be reduced.

In one particular embodiment, a low-voltage DC power supply is used in combination with a string having dual-bulb sockets and associated diode pairs to permit different decorative lighting effects to be achieved by simply reversing the direction of current flow in the string, by changing the orientation of the string plug relative to the power supply.

Another aspect of the invention is to provide spare-part storage as an integral part of the light string, so that failed bulbs and fuses can be easily and quickly replaced with a minimum of effort. Improved bulb removal devices are also provided to further facilitate bulb replacement.

In accordance with another aspect of the present invention, there is provided a repair device for fixing a malfunctioning shunt across a failed filament in a light bulb in a group of series-connected miniature decorative bulbs. The device includes a high-voltage pulse generator producing one or more pulses of a magnitude greater than the standard AC power line voltage. A connector receives the pulses from the pulse generator and supplies them to the group of series-connected miniature decorative bulbs. The pulse generator may be a piezoelectric pulse generator, a battery-powered electronic pulse generator, and/or an AC-powered electrical pulse generator.

The group of series-connected miniature decorative bulbs is typically all or part of a light string that includes wires connecting the bulbs to each other and conducting electrical power to the bulbs. The repair device preferably includes a probe for sensing the strength of the AC electrostatic field around a portion of the wires adjacent to the probe and producing an electrical signal representing the field strength. An electrical detector receives the signal and detects a change in the signal that corresponds to a change in the strength of the AC electrostatic field in the vicinity of a failed bulb. The detector produces an output signal when such a change is detected, and a signaling device connected to the detector produces a visible and/or audible signal when the output signal is produced to indicate that the probe is in the vicinity of a failed bulb. The failed bulb can then be identified and replaced.

The repair device is preferably made in the form of a portable tool with a housing that forms at least one storage compartment so that replacement bulbs and fuses can be stored directly in the repair device. The storage compartment preferably includes multiple cavities so that fuses and bulbs of different voltage ratings and sizes can be stored separated from each other, to permit easy and safe identification of desired replacement components.

The housing also includes a bulb test socket connected to an electrical power source within the portable tool to facilitate bulb testing. A functioning bulb inserted into the socket is illuminated, while non-functioning bulbs are not illuminated. A similar test socket may be provided for fuses, with an indicator light signaling whether a fuse is good or bad.

### BRIEF DESCRIPTION OF THE DRAWINGS

The invention may best be understood by reference to the following description taken in conjunction with the accompanying drawings, in which:

FIG. 1 is a schematic diagram of a string of decorative lights embodying the present invention;

FIG. 2 is a more detailed diagram of the light string shown in FIG. 1;

FIG. 3 is an enlarged and more detailed perspective view of a portion of the light string of FIG. 2;

FIG. 4 is a schematic circuit diagram of a modified power supply for use with the light string of FIGS. 1-3; and

FIG. 5 is a schematic circuit diagram of a modified power supply for use with the light string of FIGS. 1-3.

### DETAILED DESCRIPTION OF THE ILLUSTRATED EMBODIMENTS

Although the invention will be described next in connection with certain preferred embodiments, it will be understood that the invention is not limited to those particular embodiments. On the contrary, the description of the invention is intended to cover all alternatives, modifications, and equivalent arrangements as may be included within the spirit and scope of the invention as defined by the appended claims.

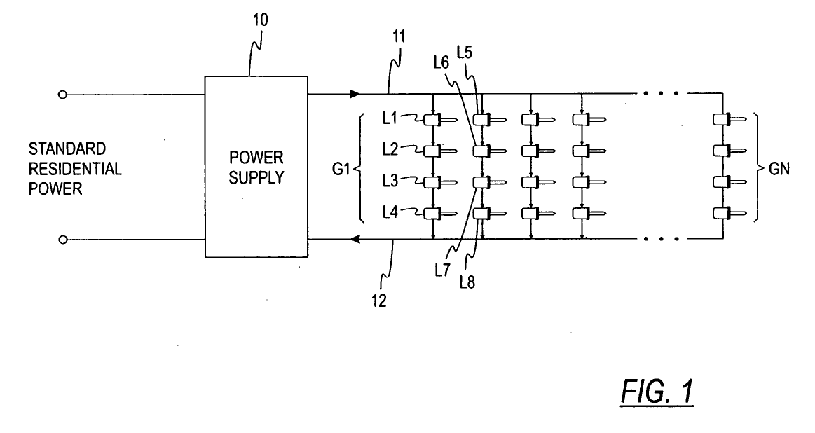

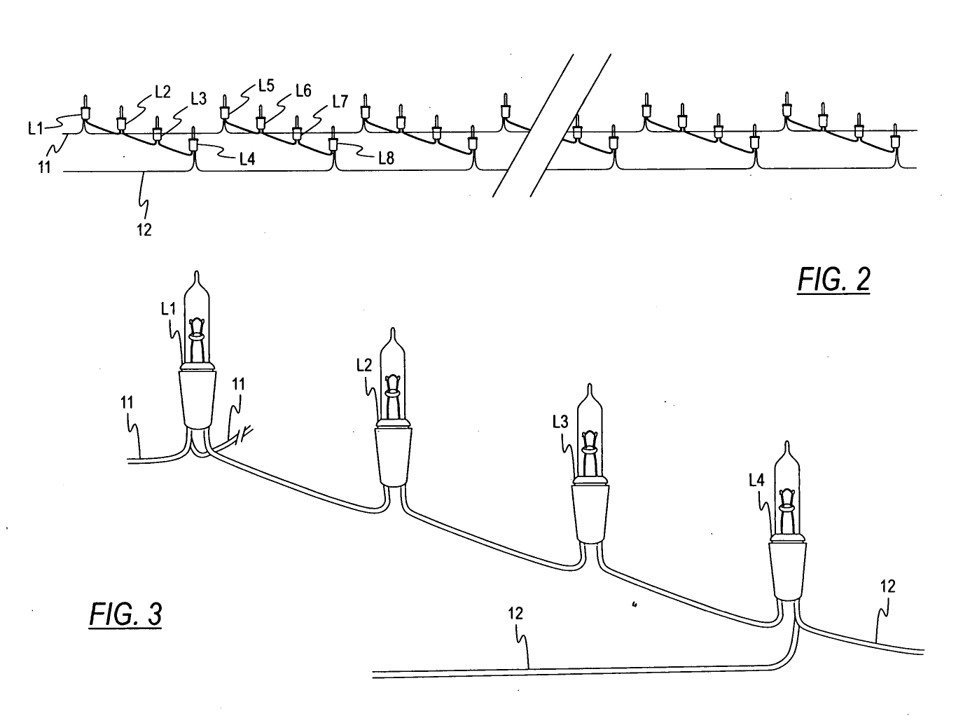

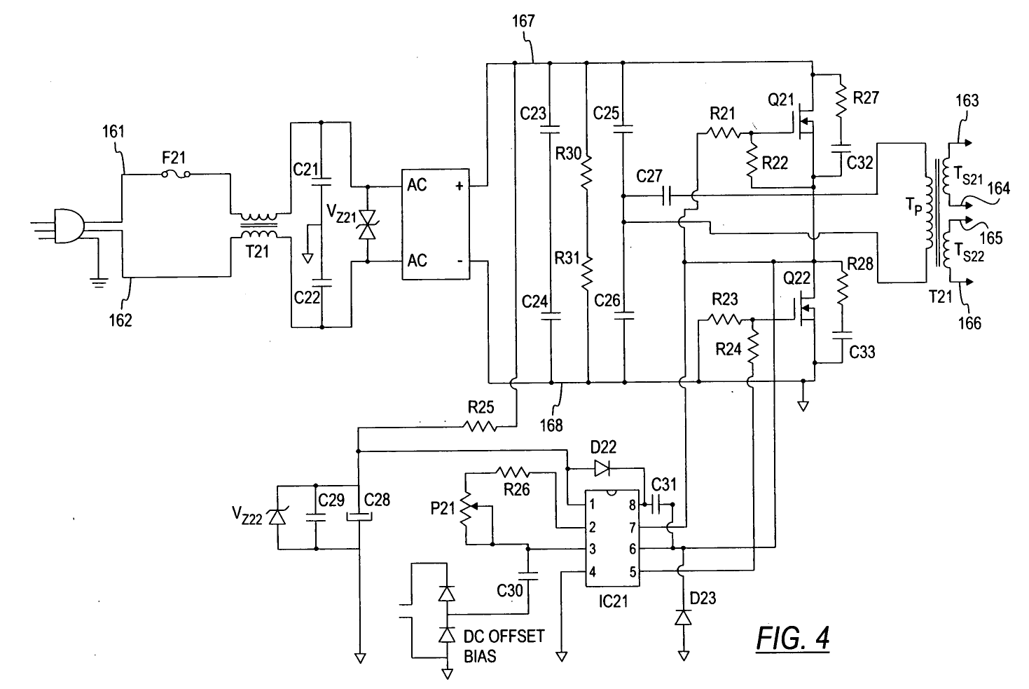

Turning now to the drawings and referring first to FIGS. 1-3, a power supply 10 is connected to a standard residential power outlet that supplies electrical power at a known voltage and frequency. In the United States, the known voltage is 120 volts and the frequency is 60 Hz, whereas in Europe and some other countries the voltage is 220-250 volts and the frequency is 50 Hz. The power supply 10 converts the standard power signal to a 24-volt, 30-KHz pulse width modulated waveform (PWM), which is supplied to a pair of parallel conductors 11 and 12 that supply power to multiple 6-volt incandescent lights L. A typical light “string” contains 100 lights L.

Multiple groups of the lights L are connected across the two conductors 11 and 12, with the lights within each group being connected in series with each other, and with the light groups in parallel with each other. For example, lights L1-L4 are connected in series to form a first light group G1 connected across the parallel conductors 11 and 12, lights L5-L8 are connected in series to form a second group G2 connected across the conductors 11 and 12 in parallel with the first group G1, and so on to the last light group Gn.

If one of the bulbs fails, the group of four series-connected lights containing that bulb will be extinguished, but all the other 96 lights in the other groups will remain illuminated because their power-supply circuit is not interrupted by the failed bulb. Thus, the failed bulb can be easily and quickly located and replaced. Moreover, there is no need for shunts to bypass failed bulbs, which is a cost saving in the manufacture of the bulbs. If it is desired to avoid extinguishing all the lights in a series-connected group when one of those lights fails, then the lights may still be provided with shunts that are responsive to the low-voltage output of the power supply. That is, each shunt is inoperative unless and until it is subjected to substantially the full output voltage of the power supply, but when the filament associated with a shunt fails, that shunt is subjected to the full output voltage, which renders that shunt operative to bypass the failed filament. A variety of different shunt structures and materials are well known in the industry, such as those described in U.S. Pat. Nos. 4,340,841 and 4,808,885.

FIG. 15 is a generalized schematic diagram of a power supply for converting a
standard 120-volt, 60-Hz input at terminals 161, 162 into a 24-volt AC output at terminals 163, 164 and 165, 166. This circuit uses a power switching supply to deliver a low-voltage, high-frequency PWM signal while also providing the following features for the light strings:
   continuous dimming capability from very low light level to full light level,
   multi-level dimming capability,
   energy-saving and minimum-light-setting features,
   soft-start feature to increase the lamp life,
   soft start feature to reduce inrush current in the circuit, and
   low cost with multi-feature lighting.

The AC input from the terminals 161, 162 is supplied through a fuse F21 to a diode bridge DB21 consisting of four diodes to produce a full-wave rectified output across buses 167 and 168, leading to a pair of capacitors C23 and C24 and a corresponding pair of transistors Q21 and Q22 forming a half bridge. The input to the diode bridge DB21 includes a dual zener diode V_{Z21} and a pair of capacitors C21 and C22 which are part of the radio frequency interference and line noise filtering circuitry. Capacitors C25 and C26 are connected in parallel with capacitors C23 and C24, respectively, to provide increased ripple current rating and high-frequency performance. The capacitors C23 and C24 may be electrolytic capacitors while capacitors C25 and C26 are film-type capacitors offering high-frequency characteristics to the parallel combination. A pair of resistors R30 and R31 are connected in parallel with the capacitors C23 and C24, respectively, to equalize the voltages across the two capacitors, and also to provide a current bleed-off path for the capacitors in the event of a malfunction or a blown fuse.

The capacitors C23, C24 form a voltage divider, and one end of the primary winding T_{P} of an output transformer T22 is connected to a point between the two capacitors. The secondary windings T_{S21} and T_{S22} of the transformer T22 are connected to the output terminals 163, 164 and 165, 166, which are typically part of a socket for receiving one or more plugs on the ends of light strings. A capacitor C27 is connected in parallel with the primary winding T_{P} and acts as a snubber across the transformer T22 to reduce voltage ringing.

An integrated circuit driver IC21, such as a IR2153 driver available from International Rectifier, drives the half bridge MOSFET transistors Q21 and Q22. The power supply for the driver IC21 is derived from the DC bus through a resistor R25 and a parallel combination of capacitors C28 and C29. The capacitor C28 is preferably an electrolytic capacitor, and the capacitor C29 is preferably a film-type capacitor offering high-frequency de-coupling characteristic to the driver IC21. A zener diode V_{Z22} clamps the voltage across the V_{CC} of the supply to ensure a safe operating limit. The zener diode V_{Z22} along with the resistor R25 provide a regulated power supply for the driver IC21. A diode D22 and a capacitor C31 provide a boot-strap mechanism for power storage to turn on the MOSFET Q21 of the half bridge.

The frequency of oscillation of the MOSFET driver is determined by the total resistance connected across pins 2 and 3 of the driver IC21 and a capacitor C30 connected across pin 3 and ground of the driver IC21. The two outputs of the IC21 pins 7 and 5 are connected to the gates of the MOSFETs Q21 and Q22. A resistor R21 limits the gate current of the MOSFET Q21. A pair of resistors R22 and R24 are connected across the MOSFETs Q21 and Q22 to reduce noise sensitivity to avoid any spurious turn-on of the MOSFETs. Resistor/capacitor combinations R27/C32 and R28/C33 are tied across the two MOSFETs Q21 and Q22 as snubbers to quench transient voltage surges at the turn-off of these transistors.

When power is applied to the circuit, the voltage developed on the bus 167 causes voltage to be applied to the IC21 V_{CC}. This causes the driver IC21 to start oscillating and start driving the half-bridge transistors Q21 and Q22 alternately. This applies voltage across the primary winding T_{P} of the transformer T21, which in turn applies voltage across the secondary windings T_{S21} and T_{S22} of the transformer, which is applied to the load.

The rectified output of the DC bus 167 is applied is applied to the Vcc of the driver IC21 through a resistor R25. A zener diode V_{Z2} and capacitors C28 and C29 are connected across the Vcc pin 1 of the driver IC21. The zener diode V_{Z2} provides regulation to the voltage applied to the Vcc of the driver IC21. The two outputs of the IC21 pins 7 and 5 are connected to the gates of the MOSFETs Q21 and Q22.

The output voltage can be varied by controlling the on/off ratio of the pulse width applied to the primary of the transformer T22. A limited dimming control can be achieved by varying the frequency of the oscillation signal from the integrated circuit IC21. The output voltage is controlled by the potentiometer P1 connected to the integrated circuit, which permits the user to adjust the light output to the desired level.

The dimming feature can be used to provide different fixed light levels, such as a low light output, an energy-saving output, or a full-light output. These three light levels can be achieved by use of three fixed resistors in place of the potentiometer P1. The three resistor settings can be selected by use of a three-position switch. A low-light output corresponds to a minimum output voltage, and a full-light output corresponds to maximum output voltage. An energy-saving output corresponds to an intermediate light level such as a 75% light output.

The bulb life can be extended by soft starting the driver IC21, so that the IC starts with minimum light output and slowly ramps up to the full or desired light level. At the time of start, the bulbs in the light string are normally cold, and the cold resistance of the bulbs is very low. The cold resistance of a bulb is typically ten times lower than the steady state, full-light operating resistance. If the full voltage were applied to a cold bulb at startup, the inrush bulb current could be ten times the rated current of the bulb, which could cause the bulb filament to weaken and ultimately break. By soft starting the control circuit, the voltage applied during starting of the bulb is significantly lower. As the bulb heats up and the bulb resistance increases, the voltage is increased. Thus the bulb current never exceeds its hot rating, which increases bulb life.

Soft starting of the circuit also helps reduce the inrush current from the circuit, thereby avoiding any interaction with other circuits or appliances. Soft starting in this circuit can be achieved by starting the driver IC21 at high frequency and then reducing it to the desired operating point with a small delay e.g. one second. This could be accomplished in the circuit shown by adding a DC offset voltage to the ground return of capacitor C30. This offset could be generated either by a time delayed voltage source derived from Bus 167 or a feedback loop detecting the output current and maintaining a feedback voltage on C30 ground return keeping the output current constant.

If a wider range of dimming control is needed, the driver IC21 can be replaced by another integrated circuit, such as an IR21571, along with a PWM controller to drive the FETs, thereby providing a full range of pulse width modulation. The output can be controlled from almost zero light to full light.

The particular embodiment illustrated in FIG. 15 is a half bridge circuit as an example for but it will be understood that the features of this circuit can be incorporated in other topologies such as flyback, forward, cuk, full bridge or other power converters, including isolated as well as non-isolated power converter designs.

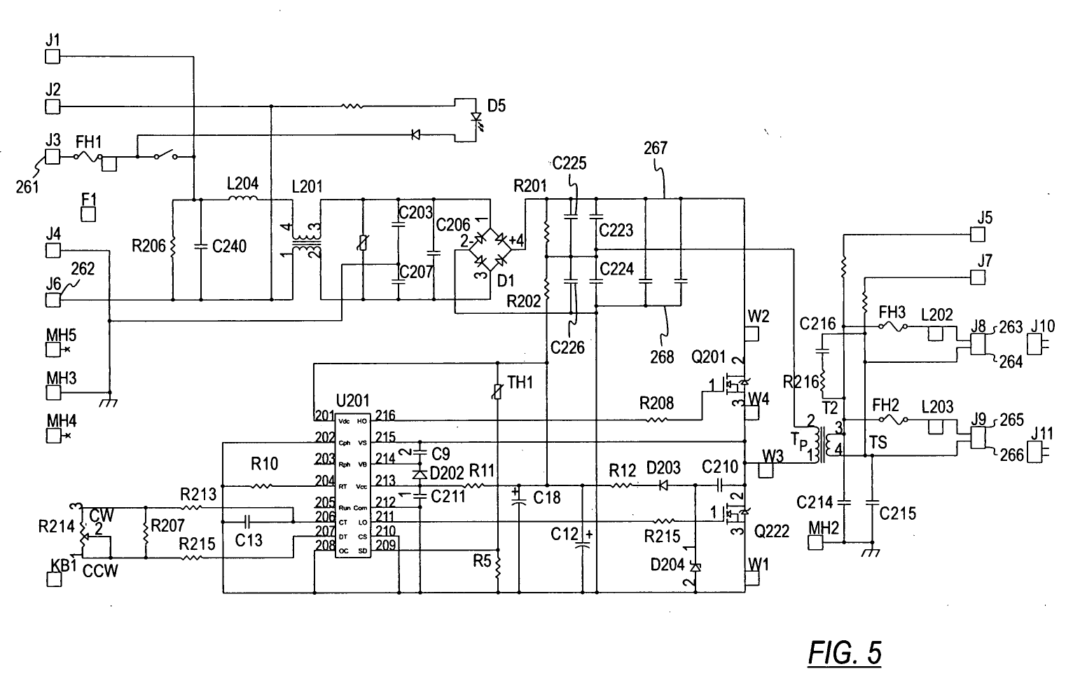

FIG. 5 is another schematic diagram of a power supply for converting a
standard 120-volt, 60-Hz input at terminals 261, 262 into a 24-volt AC output at terminals 263, 264 and 265, 266. This circuit uses a switching power supply to deliver a low-voltage, high-frequency PAM signal while also providing the following features for the light strings:
   continuous dimming capability from very low light level to full light level,
   multi-level dimming capability,
   energy-saving and minimum-light-setting features,
   soft-start feature to increase the lamp life,
   soft start feature to reduce inrush current in the circuit, and
   low cost with multi-feature lighting.

The AC input from the terminals 261, 262 is supplied through a fuse FH201 to a diode bridge DB221 consisting of four diodes to produce a full-wave rectified output across buses 267 and 268, leading to a pair of capacitors C223 and C224 and a corresponding pair of transistors Q221 and Q222 forming a half bridge. The input to the diode bridge DB221 includes a passive component network consisting of C203, C204, C206, C207, L201, L204 and RV201 which are part of the radio frequency interference and line noise filtering circuitry. Capacitors C225 and C226 are connected in parallel with capacitors C223 and C224, respectively, to provide increased ripple current rating and high-frequency performance. The capacitors C223 and C224 may be electrolytic capacitors while capacitors C225 and C226 are film-type capacitors offering high-frequency characteristics to the parallel combination.

The capacitors C223, C224 form a virtual center tap. One end of the primary winding T_{P} of an output transformer T222 is connected to a point between the two capacitors. The secondary winding T_{S} of the transformer T222 is connected to the output terminals 263, 264 and 265, 266, through series inductors L202 and L203 (along with C214, C215, C216 and R216) which act as filters to minimize electromagnetic interference. The output terminals receive one or more plugs on the ends of light strings.

An integrated circuit driver U201, such as a IR21571D controller available from International Rectifier, controls the switching frequency of oscillation and other features indicated above. The power supply V_{cc} for the driver U201 is derived from the DC bus through a resistors R201 and R202 to an internal zener diode. The device includes protection elements which prohibit starting oscillation (operation) until the power supply voltages are in tolerance and if there is a fault which interferes with the proper sequencing of voltages V_{DC}, V_{CC}, and V_{SD}-Diodes D202, D203, D204 and capacitors C209, C210 and C211 provide a boot-strap mechanism for powering the IC. C212 and C218 provide bulk storage to start the controller at power up.

The frequency of oscillation of the controller is determined by the total resistance connected to ground from pin 204 of the controller U201 and a capacitor C213 connected across pin 206 and ground of the controller U201. The two outputs of the U201 pins 211 and 216 are connected to the gates of the MOSFETs Q221 and Q222. A resistor R208 limits the gate current of the MOSFET Q221. A resistor R215 limits the gate current of the MOSFET Q222.

When power is applied to the circuit, the voltage developed on the bus 267 causes voltage to be applied to U201 V_{CC}, V_{DC}, and V_{SD}. This causes the U201 to start oscillating and start driving the half-bridge transistors Q221 and Q222 alternately. This applies voltage across the primary winding T_{P} of the transformer T221, which in turn applies voltage across the secondary winding T_{S} of the transformer, which is applied to the load.

The rectified output of the DC bus 267 is applied to the Vcc and V_{DC} pins of the controller U201 through resistors R201 and R202. An internal zener diode and capacitors C218 and C212 maintain the operating voltages for the controller. A voltage divider consisting of a thermistor TH1 and R205 set the value V_{SD}. The controller uses these three voltages to determine the state of the power bus 267 to prevent operation when the power bus has collapsed.

The preset output voltage is set by the turns ratio of the output transformer T202. A limited dimming control is achieved by adjusting the resistance that appears between pins 206 and 207 of controller U201. This resistance controls the amount of dead time for the output FETs which reduces the RMS value of the output voltage of T202 and thereby reducing the intensity of the light strings connected to terminals 263, 264 and 265, 266.

The dimming feature can be used to provide different fixed light levels, such as a low light output, an energy-saving output, or a full-light output. These three light levels can be achieved by use of three fixed resistors in place of the potentiometer R214. The three resistor settings can be selected by use of a three-position switch. A low-light output corresponds to a maximum output dead time, and a full-light output corresponds to minimum dead time. An energy-saving output corresponds to an intermediate light level such as a 75% light output.

The controller has an additional control pin (SD) which can be used as a thermal shutdown control to protect the power supply from overheating. As the air temperature in the unit rises, the value of TH201 will decline until the voltage appearing at pin 209 of U201 rises above the shut down value of approximately 2.0 volts.

The particular embodiment illustrated in FIG. 5 is a half bridge circuit as an example but it will be understood that the features of this circuit can be incorporated in other topologies such as flyback, forward, cuk, full bridge or other power converters, including isolated as well as non-isolated power converter designs.

1. A string of decorative lights comprising
a power supply having an input adapted for connection to a standard residential electrical power outlet, said power supply including circuitry for converting the standard residential voltage to a low-voltage output, the input connected through a fuse to a diode bridge,
a pair of conductors connected to the output of said power supply for supplying said low-voltage output to multiple decorative lights, and
multiple lights connected to said conductors along the lengths thereof, each of said lights, or groups of said lights, being connected in parallel across said conductors.

2. A string of decorative lights as set forth in claim 1 wherein each of said lights is about a half-watt bulb.

3. A string of decorative lights as set forth in claim 1 wherein each of said lights requires a voltage or about 6 volts or less.

4. A string of decorative lights as set forth in claim 1 wherein said lights are connected in parallel across said conductors in parallel groups of two to five lights per group, the lights within each group being connected in series.

5. A string of decorative lights as set forth in claim 1 wherein said standard residential voltage is 120 volts and approximately 100 6-volt lights are connected to said conductors.

6. A string of decorative lights as set forth in claim 1 wherein said low-voltage output is DC.

7. A string of decorative lights as set forth in claim 1 wherein said low-voltage output is AC.

8. A string of decorative lights as set forth in claim 1 wherein said low-voltage output is less than about 30 volts.

9. A string of decorative lights as set forth in claim 1 wherein said power supply comprises an electronic transformer.

10. A string of decorative lights as set forth in claim 1 wherein said power supply comprises a switching power supply.

11. A string of decorative lights as set forth in claim 1 wherein said power supply converts the standard residential frequency to a higher frequency output.

12. A string of decorative lights as set forth in claim 11 wherein said higher frequency is in the range from about 10 KHz to about 150 KHz.

13. A string of decorative lights as set forth in claim 1 wherein said conductors are connected to a fixed number of said lights so as to provide a fixed load on said power supply.

14. A string of decorative lights as set forth in claim 1 wherein each of said lights includes means for shunting the light in response to a failure of the light.

15. A decorative lighting system, said system comprising
a power supply having an input adapted for connection to a standard residential electrical power outlet, said power supply including circuitry for converting the standard residential voltage to a low-voltage output, the input connected through a fuse to a diode bridge,
a plurality of pairs of conductors connected to the output of said power supply for supplying said low-voltage output to multiple sets of decorative lights, and
multiple lights connected to each pair of said conductors along the lengths thereof, each of said lights, or groups of said lights, being connected in parallel across each of said pairs of conductors.

16. A decorative lighting system as set forth in claim 15 wherein each of said lights is about a half-watt bulb.

17. A decorative lighting system as set forth in claim 15 wherein each of said lights requires a voltage or about 6 volts or less.

18. A decorative lighting system as set forth in claim 15 wherein each of said pairs of conductors has multiple groups of said lights connected in parallel across the conductor pair, each of said parallel groups including two to five lights connected in series within the group.

19. A decorative lighting system as set forth in claim 15 wherein said standard residential voltage is 120 volts and approximately 100 6-volt lights are connected to each of said pairs of conductors.

20. A decorative lighting system as set forth in claim 15 wherein said low-voltage output is DC.

21. A decorative lighting system as set forth in claim 15 wherein said low-voltage output is AC.

22. A decorative lighting system as set forth in claim 15 wherein said low-voltage output is less than about 30 volts.

23. A decorative lighting system as set forth in claim 15 wherein said power supply comprises an electronic transformer.

24. A decorative lighting system as set forth in claim 15 wherein said power supply comprises a switching power supply.

25. A decorative lighting system as set forth in claim 15 wherein said power supply converts the standard residential frequency to a higher frequency output.

26. A decorative lighting system as set forth in claim 25 wherein said higher frequency is in the range from about 10 KHz to about 150 KHz.

27. A decorative lighting system as set forth in claim 15 wherein each of said pairs of conductors is connected to a fixed number of said lights so as to provide a fixed load on said power supply.

28. A decorative lighting system as set forth in claim 15 wherein each of said lights includes means for shunting the light in response to a failure of the light.

29. A method of powering a string of decorative lights, said method comprising
converting a standard residential electrical voltage to a low-voltage, using a power supply having an input coupled through a fuse to a diode bridge, and
supplying said low-voltage to a pair of parallel conductors having multiple decorative lights connected to said conductors along the lengths thereof, each of said lights, or groups of said lights, being connected in parallel across said conductors.

30. A method of powering a string of decorative lights as set forth in claim 29 wherein each of said lights is about a half-watt bulb.

31. A method of powering a string of decorative lights as set forth in claim 29 wherein each of said lights requires a voltage or about 6 volts or less.

32. A method of powering a string of decorative lights as set forth in claim 29 wherein said lights are connected in parallel across said conductors in parallel groups of two to five lights per group.

33. A method of powering a string of decorative lights as set forth in claim 29 wherein said standard residential voltage is 120 volts and approximately 100 6-volt lights are connected to said conductors.

34. A method of powering a string of decorative lights as set forth in claim 29 wherein said low-voltage output is DC.

35. A method of powering a string of decorative lights as set forth in claim 29 wherein said low-voltage output is AC.

36. A method of powering a string of decorative lights as set forth in claim 29 wherein said low-voltage output is less than about 30 volts.

37. A method of powering a string of decorative lights as set forth in claim 29 wherein an electronic transformer is used in the conversion of said standard residential electrical voltage to a low voltage.

38. A method of powering a string of decorative lights as set forth in claim 29 wherein a switching power supply is used in the conversion of said standard residential electrical voltage to a low voltage.

39. A method of powering a string of decorative lights as set forth in claim 29 wherein the standard residential frequency is converted to a higher frequency output.

40. A method of powering a string of decorative lights as set forth in claim 39 wherein said higher frequency is in the range from about 10 KHz to about 150 KHz.

41. A method of powering a string of decorative lights as set forth in claim 29 wherein a fixed load is maintained on said conductors by limiting the number of lights connected to said conductors to a fixed number.
